(19) United States
(12) Patent Application Publication
(10) Pub. No.: US 2004/0105744 A1
(43) Pub. Date: Jun. 3, 2004

(54) Moveable load floor convenience center in automotive applications

(76) Inventors: Donald H. Warner, Rochester Hills, MI (US); Michael N. Ruppert, Rochester Hills, MI (US); Robert L. Morse, Shelby Twp., MI (US)

Correspondence Address: STEVEN J. GROSSMAN, GROSSMAN, TUCKER, PERREAULT & PFLEGER, PLLC, 795 ELM STREET/STE. 604, MANCHESTER, NH, 03101, US

(21) Appl. No.: 09/950,122

(22) Filed: Sep. 10, 2001

(51) Int. Cl. B60P 1/00

(52) U.S. Cl. 414/522

(57) ABSTRACT

A moveable load floor assembly for a vehicle comprising a top load-bearing surface and a concealed storage compartment located underneath the top load-bearing surface. The assembly is movable forward and rearward within the vehicle in order to position said assembly both inside and outside the vehicle, the assembly operating to cover and conceal a vehicle storage compartment.

### FIELD OF THE INVENTION

This invention relates to moveable load floor assemblies for motor vehicles and, in particular, to a top load-bearing assembly which has concealed storage bins built in, and which further, can be re-positioned either inside or outside the vehicle to allow access to the top surface storage area, to the concealed bins and to storage space such as for a spare tire underneath.

### BACKGROUND OF THE INVENTION

With the increased popularity of multi-purpose motor vehicles, such as sports utility, minivans, extended cab pickups, etc., storage space to support a variety of activities is desired. In addition, there continues to be a need to gain access to the spare tire compartment as well as to ease the burden of loading heavy or bulky items into the vehicle's storage area. The length of the storage area reduces any leverage to manipulate large, heavy packages and many vehicle designs contain a sealing lip at the rear of the vehicle that items must be lifted over.

In addition, storage space in the rear of these vehicles is often untidy as few compartments exist in which to store smaller items (sports equipment, running shoes, cameras, binoculars, umbrellas and the like).

Load panels for the luggage area of a motor vehicle are well known. A number of patents disclose moveable structures which enhance the loading and unloading of cargo in various motor vehicles. These structures are generally moveable between a first and second position and are mounted above the existing load floor of the vehicle. Attention is directed to U.S. Pat. Nos. 2,284,419; 2,470,314; 2,576,385; 3,028,025; 3,132,755; 3,768,673; 4,824,158; 4,841,883; 4,950,123; 5,046,913; 5,052,878 and 5,064,335. U.S. Pat. Nos. 2,797,828, 5,544,998 and 5,944,371 disclose structures that form the load floor when they are positioned within the vehicle as opposed to a moveable structure that is above an existing load floor.

U.S. Pat. No. 3,338,620 to Cauvin relates to a folding table for camping, the top of which is part of the floor of the rear compartment of a vehicle. The table is disconnected from the vehicle in order to be used as a table.

U.S. Pat. No. 4,230,246 to Wilson relates to a moveable structure for mounting within the trunk of an automobile to hold the spare tire and allow the spare tire to be moved between a stored, out-of-the-way location and an easily accessible location. The moveable structure allows the tire to be moved between the two positions without having to remove items from the luggage compartment located below the apparatus.

U.S. Pat. No. 4,303,367 to Bolt discloses a container having a plurality of open-topped receptacles for supporting loaded shopping bags in an upright position. The receptacle is either slidable or rotatable only between a first position and a second position to ease loading and unloading of articles. The container is attachable to an existing station wagon floor surface.

U.S. Pat. Nos. 4,725,183 to Smillie and 4,799,849 to Miller each disclose a motorized apparatus for lifting items between an elevated position and a lowered position in an automobile trunk. In the elevated position, items on the apparatus can be easily removed without having to reach down into the trunk. In the lowered position, the trunk lid can be closed and the items transported

U.S. Pat. Nos. 4,752,095 to Brady and 5,088,636 to Barajas each disclose a tool box with a plurality of drawers and compartments moveable between two extreme positions in a pick-up truck.

Finally, U.S. Pat. No. 4,969,678 to Loisel discloses a box design to be accommodated at the rear of a vehicle. The top surface of the box forms a horizontal, sleeping plane. The box houses compartments for a refrigerator, a gas stove, a sink, and other items. The stove and sink are capable of movement between a position in the vehicle and a position outside the rear of the vehicle.

However, none of the references contemplate a top load-bearing floor assembly that is moveable to a position within the vehicle that would allow the user to access items covered by that assembly, and which contains concealed storage compartments as part of that moveable assembly, and which further is also moveable to a cantilevered position extending out over the end of the vehicle to provide access to items stored under the load floor and to ease the loading effort for items that will be stored on said load floor.

In addition, by providing an integrated modular assembly, the aesthetics of the vehicle storage area are greatly improved over the prior art.

### SUMMARY OF THE INVENTION

It is the object of the present invention to overcome the limitations of the prior known load floors by providing a top loadable modular assembly which has concealed storage compartments and is repositionable both inside and outside the vehicle for access.

According to the invention, this object is achieved by providing a vehicle moveable load floor assembly that can be moved between a first and second position inside a vehicle and a third position outside the rear of the vehicle. In the first position, the load floor assembly is located above a spare tire or other storage compartment of the vehicle. In the second position, the load floor assembly is located over a folded-down back seat that allows access to the spare tire or storage compartment. The storage compartment may include one or more interchangeable bins which can be utilized for improved versatility and allow the user to configure the storage area to meet their individual needs. In the third position, the load floor assembly is cantilevered outside the vehicle to allow the user more ergonomic access to items stored on the top surface of the load floor assembly. The load floor assembly preferably includes at least one storage compartment within the assembly that is concealed by a top cover panel or door which forms the top load bearing surface of the assembly. The load floor assembly storage compartment may also be fitted with one or more interchangeable bins. As a result, the user is afforded ergonomic access to items stored on the top surface of the load floor assembly, as well as to storage compartments located beneath the load floor assembly in the vehicle.

Accordingly, the present invention is directed at a moveable load floor assembly for a vehicle comprising a top load-bearing surface and a concealed storage compartment located underneath said top load bearing surface, said assembly movable forward and rearward within said vehicle in order to position said assembly both inside and outside the vehicle. The movable assembly may be slidably engaged to said vehicle. The movable load floor assembly may contain a storage compartment and the load floor assembly, when positioned in said vehicle, covers said storage compartment. The load floor assembly may also include a plurality of concealed storage compartments, optionally made of an insert that fits within said movable load floor assembly. The load floor assembly made be molded of a thermoplastic or thermoset material.

The movable load floor assembly may also include one or a plurality of stop structures for securing movement of said assembly at a desired position inside or outside said vehicle. The assembly may also include a grasping structure comprising a molded-in recess structure.

### BRIEF DESCRIPTION OF THE DRAWINGS

These and other objects, features and advantages of the invention will become apparent upon consideration of the description of this invention and the appended drawings in which:

FIG. 1 shows a perspective view of the rear interior of a minivan with the load floor assembly of the invention in the extended state.

FIG. 2 is a partial view of FIG. 1 showing how the top of the load floor assembly would be articulated for access underneath.

FIG. 3 is a perspective view of the rear interior of a sports utility vehicle showing the load floor assembly of the invention and various concealed storage compartments and means for their access.

FIG. 4 is a perspective view of the rear interior of a minivan showing another embodiment of interchangeable storage compartments.

FIG. 5 is a perspective view of a preferred embodiment of the invention illustrating the 3 positions that the moveable load floor assembly can occupy.

FIG. 6 is a more detailed view of FIG. 5 showing alternate means for accessing the concealed storage compartment.

FIG. 7 is another view of the same vehicle in FIG. 6 with the moveable load floor of the invention in the forward position to allow access to the spare tire.

The above and other objects, features and advantages of the present invention will be 20 apparent in the following detailed description thereof when read in conjunction with the appended drawings wherein the same reference characters denote the same or similar paths throughout the several views.

### DESCRIPTION OF THE PREFERRED EMBODIMENTS

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly referenced at 10A, 10B, and so forth in subsequent embodiments. Thus, where an embodiment description uses a reference character to refer to an element, the reference character applies equally, as distinguished by alphanumeric character, to the other embodiments where the element is common.

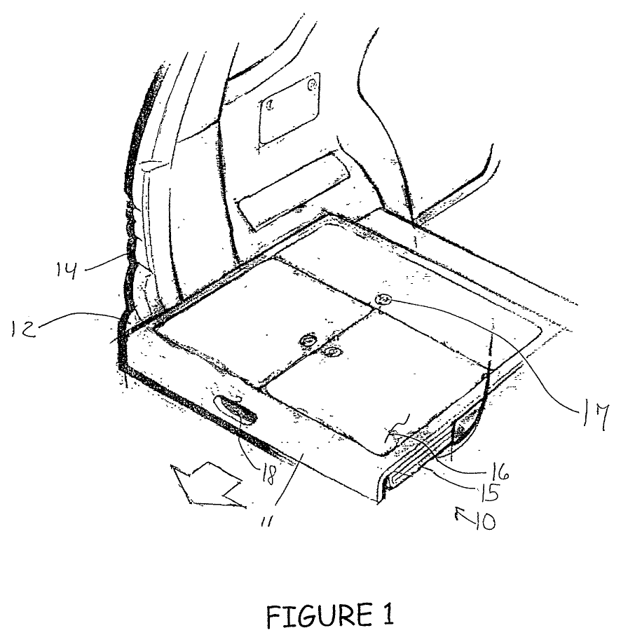

Referring now to the figures, FIG. 1 shows the moveable load floor assembly 10 of the present invention in an extended position over the rear bumper 12 of a representative minivan vehicle 14. The present invention can work in any vehicle having a moveable rear door, trunk lid, or hatch. The top load surface 16 of the moveable load floor assembly may be covered with a soft frictioned surface, such as carpeting, or may be of a molded plastic having a grain pattern that is complementary with the surrounding interior trim panels. In its extended position as shown, the load floor assembly provides for ease of loading large, bulky or heavy items onto the surface without having to lift those items over a lip or having to extend one's body into the vehicle interior to position those items, an awkward and dangerous ergonomic situation. Subsequently, the load floor assembly can slide along a telescoping rail mechanism 15 to store the items within the minivan's interior.

These telescoping rail mechanisms are preferably dual acting heavy duty drawer guides from Accuride International, Inc. but can be of any similar mechanism that provides for sliding movement in either direction with stops built-in to prevent over-travel. The telescoping rail mechanism may be attached between each side of the moveable load floor assembly and a spare tire compartment wall or a vehicle subfloor to allow smooth movement and extension of the assembly between each of the various positions. The telescoping rail mechanism comprises track housings and a rail supported by a plurality of bearings. Alternatively, the rail mechanism may comprise at least one longitudinally extending groove formed in a sub floor of the vehicle that cooperates with a protrusion extending from the load floor. A grasping handle 18 is molded in as a recessed structure or attached to the foremost and/or rearmost wall to ease the sliding movement of the load floor. As a recessed structure, those skilled in the art will appreciate that as the vehicle tailgate closes against surface 11, the recessed handle will not interfere with the tailgate, and close mating tolerances can be achieved.

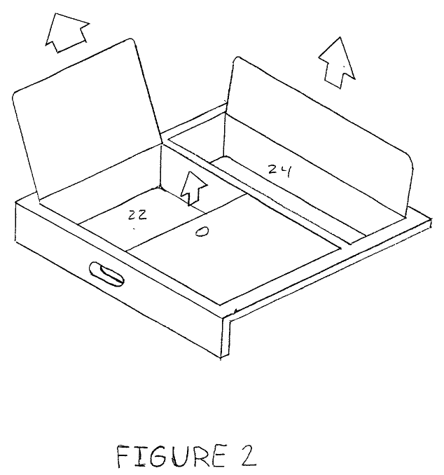

Latches are shown at 17 which can be turned to unlatch the doors which can be hinged upward, as shown in FIG. 2. The latches may alternately be key locks which can be turned to prevent unwanted access or theft. Also shown in FIG. 2 are concealed compartments, 22 and 24, which can store a variety of items out of sight.

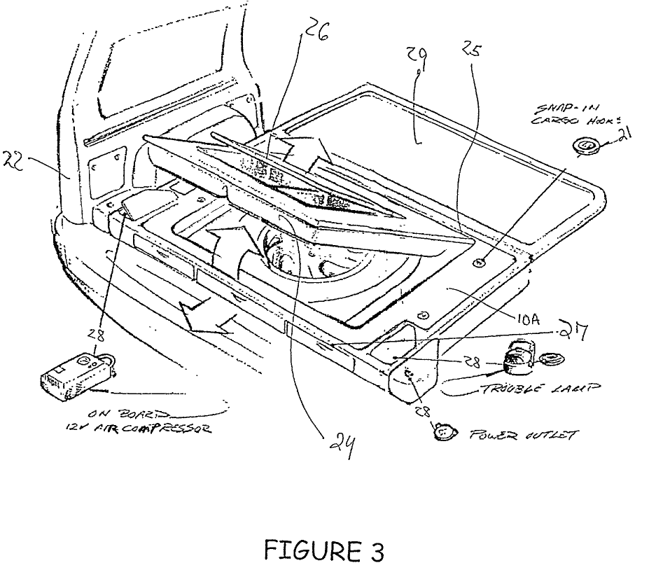

FIG. 3 shows another preferred embodiment of the invention, in this case as a moveable load floor assembly for a representative sports utility vehicle 22. In this embodiment, some additional features are shown. The generally rectangular moveable load floor assembly is shown at 10A. In addition to the slidable movement of the load floor fore and aft to assist loading, the load floor module may have a center storage section 24 which can be rotated upward around a hinge 25 to access the spare tire compartment underneath. In addition, the center storage section 24 also may have access through a hinged cover 26. In addition, there may be a series of horizontally sliding drawers 27 which might contain tools or a fire extinguisher. Further, there may be hinged covers 28 over compartments on each side of the load floor assembly that could contain a trouble light, small air compressor or 12 volt power outlet, etc. The load floor assembly may be made to coordinate with the vehicle interior appearance with a hinged panel 29, that fully closes out and covers all of the hinged storage compartments. Finally, the top section of the load floor assembly can include cargo hooks 21 snapped into place, to aid in securing items in place with cords so that they won't move during transit.

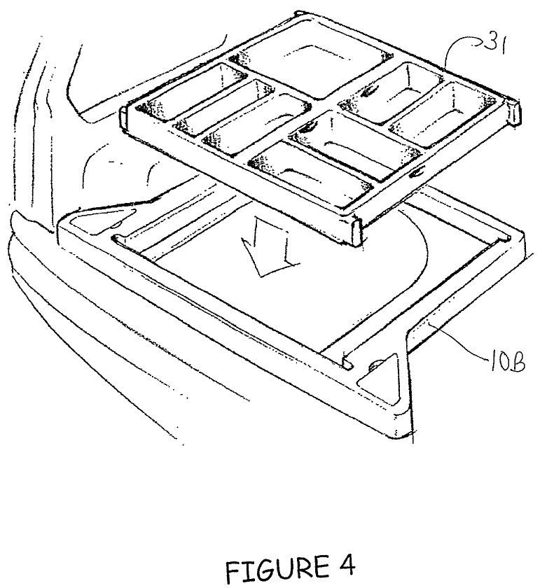

Turning to FIG. 4, an alternative preferred embodiment is shown, wherein the storage compartments comprise a molded tray 31 which can fit inside the moveable load floor assembly 10B to store a variety of tools, accessories, sporting equipment, toys, etc. The molded tray may be interchangeable with other similar trays having different shaped compartments to accept other types of items. Again, this can be closed out and secured by a hinged top panel (not shown) and can slide rearward to a position cantilevered over the vehicle bumper for ease of access.

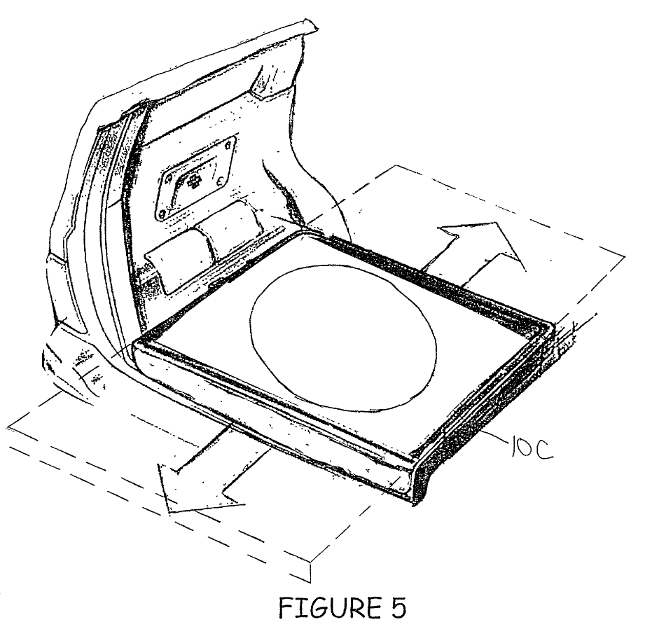

FIGS, 5, 6 and 7 show other preferred embodiment of the invention where the moveable load floor assembly can be positioned in any of at least three alternate positions: in a “travel’ position located over a spare tire compartment; in an “extended’ position cantilevered over the rear bumper for loading or easy access to the concealed storage compartment; or in a “forward” position to allow access to the spare tire compartment. FIG. 5 shows an assembly 10C in the “travel” position. The assembly can be slidably moved forward in the vehicle to the “forward” position or backward in the vehicle to the “extended’ position, as shown by dashed lines.

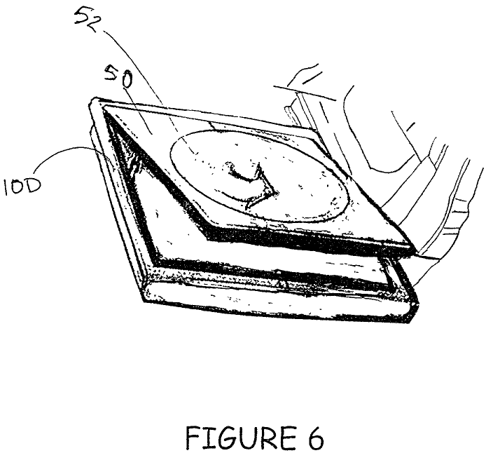

FIG. 6 shows a generally rectangular moveable load floor assembly 10D in the “extended” position with panels 50 or 52 along the top which can be hinged or rotated respectively for access to the concealed storage compartments. In the “extended” position, at least a portion of the assembly extends over the rear of the vehicle.

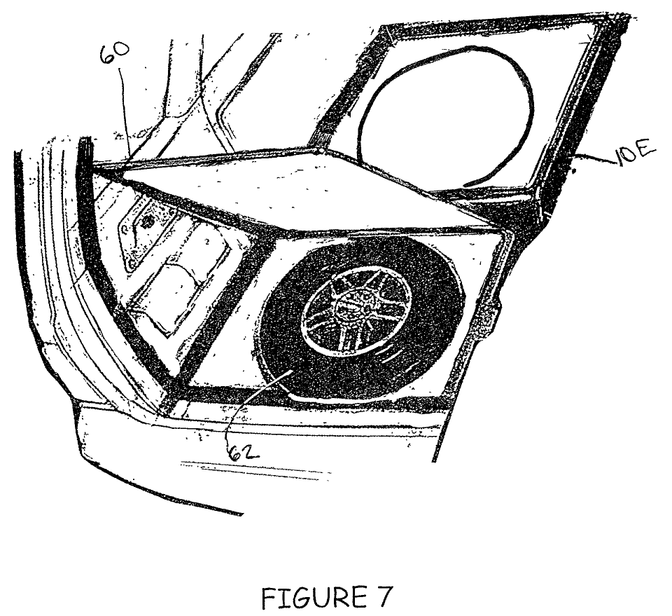

FIG. 7 shows the moveable load floor assembly 10E of the invention in the “forward” position where the rear row of seats of the vehicle has been repositioned to allow the assembly to slide forward to gain access to the spare tire 62. In this example, an optional dust cover 60 is shown hinged above the spare tire 62.

Thus, it can be seen that the invention provides a new and improved top load bearing floor assembly for a vehicle having concealed storage compartments, configurable for a variety of items, which is moveable both inside and outside the vehicle to load, store or access items. Additionally, the invention also provides for secure and more orderly storage of tools, sporting equipment, toys and the like.

The description and drawings illustratively set forth the presently preferred invention embodiments. The description and drawings are intended to describe these embodiments and not to limit the scope of the invention. Those skilled in the art will appreciate that still other modifications and variations of the present invention are possible in light of the above teaching while remaining within the scope of the following claims. Therefore, within the scope of the claims, one may practice the invention otherwise than as the description and drawings specifically shown and described.

We claim:

1. A moveable load floor assembly for a vehicle comprising:
a top load-bearing surface and a concealed storage compartment located underneath said top load bearing surface, said assembly movable within said vehicle in order to position said assembly both inside and outside the vehicle,
wherein said load floor assembly, when in a first position covers a storage compartment in the vehicle.

2. The movable load floor assembly of claim 1 wherein said movable assembly is slidably engaged to said vehicle.

3. The movable load floor assembly of claim 1 wherein said storage compartment is a spare tire compartment.

4. The movable load floor assembly of claim 1, wherein said load floor assembly includes a plurality of storage compartments concealed below said load bearing surface.

5. The movable load floor assembly of claim 4, wherein said plurality of concealed storage compartments comprise an insert that fits within said movable load floor assembly.

6. The movable load floor assembly of claim 1, further comprising a drawer slidably engageable with said load floor assembly.

7. The moveable load floor assembly of claim 1, wherein said top load-bearing surface is comprised of at least one door which can be repositioned to provide access to an item located beneath the top load-bearing surface.

8. The movable load floor assembly of claim 7, wherein said door is hinged to provide access to the item located beneath the top load-bearing surface.

9. The movable load floor assembly of claim 7, wherein said door is rotatable to provide access to the item located beneath the top load-bearing surface.

10. The movable load floor assembly of claim 1, wherein said top loading-bearing surface is molded of plastic.

11. The movable load floor assembly of claim 5, wherein said insert is molded of plastic.

12. The moveable load floor assembly of claim 1, further comprising a pair of longitudinally telescoping rail mechanisms each adapted to slidably cooperate with said vehicle in order to position said assembly both inside and outside the vehicle.

13. The movable load floor assembly of claim 12, wherein the rail mechanism comprises at least one stop structure for securing movement of said assembly at a desired position inside or outside said vehicle.

14. The moveable load floor assembly of claim 1, further comprising a recess molded into said load floor assembly for grasping the assembly.

15. The moveable load floor assembly of claim 1, wherein said load floor assembly is lockable in a position outside of said vehicle.

16. A moveable load floor assembly for a vehicle, comprising:
a top load-bearing surface supported by at least one longitudinal rail, the load-bearing surface positionable in a first position disposed above a storage compartment, a second position closer to a front end of the vehicle than the first position, the second position allowing access to the storage compartment, and a third position in which at least a portion of the assembly extends over a rear of the vehicle.

17. The moveable load floor of claim 16, wherein the storage compartment comprises a spare tire.
